(19) United States
(12) Patent Application Publication
(10) Pub. No.: US 2013/0311695 A1
(43) Pub. Date: Nov. 21, 2013

(54) Flexray Gateway and Method for Operating a Flexray Gateway

(71) Applicant: Vector Informatik GmbH, Stuttgart (DE)

(72) Inventors: Martin Gossner, Stuttgart (DE); Olav Augustin, Stuttgart (DE); Jochen Braun, Stuttgart (DE); Markus Fischer, Stuttgart (DE)

(73) Assignee: Vector Informatik GmbH, Stuttgart (DE)

(21) Appl. No.: 13/894,977

(22) Filed: May 15, 2013

(30) Foreign Application Priority Data
May 18, 2012 (EP) EP12003938.3

(51) Int. Cl. G06F 13/42

(52) U.S. Cl. CPC G06F 13/4221
USPC 710/313

(57) ABSTRACT

A Flexray gateway comprising a first and a second bus interface for connecting a first and a second Flexray bus, wherein the Flexray gateway comprises coupling means for coupling a first and a second Flexray bus and for transmitting bus messages between the first and the second Flexray bus, wherein the Flexray gateway comprises a Flexray controller with a first and a second channel interface for transmitting and receiving bus messages of a first and a second channel type of a Flexray bus.

### CROSS-REFERENCE TO RELATED APPLICATIONS

This application claims priority to EP12003938.3, filed May 18, 2012.

### BACKGROUND OF THE INVENTION

The invention relates to a Flexray gateway comprising a first bus interface for connecting a first Flexray bus and a second bus interface for connecting a second Flexray bus, wherein the Flexray gateway comprises coupling means for coupling a first Flexray bus to a second Flexray bus and for transmitting bus messages between the first and the second Flexray bus, wherein the Flexray gateway comprises a Flexray controller with a first channel interface for transmitting and receiving bus messages of a first channel type of a Flexray bus and a second channel interface for transmitting and receiving bus messages of a second channel type of a Flexray bus. The invention further relates to a method for operating a Flexray gateway of this type.

A so-called Flexray bus has an A channel and a B channel which are physically separated from one another. For transmitting data on a Flexray bus, a suitable Flexray controller, which is also referred to as communication controller, has two channel interfaces for transmitting and receiving data on the first channel and on the second channel, for example the A channel and the B channel. For the direct connection of the Flexray controller to the Flexray bus, a so-called bus transceiver is further required, which, in a manner of speaking, serves the physical level or the physical layer.

Although the bus messages—so-called frames—may in principle be constructed identically on an A channel and a B channel, they have different check sums. For this reason, an A channel of one Flexray bus cannot directly communicate with a B channel of another Flexray bus. This being so, a Flexray controller cannot communicate with two A channels of different Flexray busses. If therefore two Flexray busses are to be linked by means of a gateway, for example to provide a so-called rest bus simulation for a Flexray bus, at least two Flexray controllers are required.

### SUMMARY OF THE INVENTION

The present invention is therefore based on the problem of providing a Flexray gateway which is constructed as simply as possible and a suitable method for operating a Flexray gateway which is constructed as simply as possible.

To solve this problem, it is provided in a Flexray gateway of the type referred to above that the coupling means are configured for coupling a channel connection of the first bus interface, which is provided for transmitting bus messages of the first channel type, to a channel connection of the second bus interface, which is likewise provided for transmitting bus messages of the first channel type, and that the coupling means comprise at least one adapting module for adapting bus messages of the first channel type received at the second bus interface to bus messages of the second channel type and for relaying them to the second channel interface of the Flexray controller and/or for adapting bus messages of the second channel type transmitted via the second channel interface of the Flexray controller to bus messages of the first channel type and for relaying them to the second bus interface.

The method according to the invention for operating a Flexray gateway comprising a first bus interface for connecting a first Flexray bus and a second bus interface for connecting a second Flexray bus comprises the steps of:
coupling a channel connection of the first bus interface, which is provided for transmitting bus messages of the first channel type, to a channel connection of the second bus interface, which is likewise provided for transmitting bus messages of the first channel type, and transmitting bus messages between the channel connections,
transmitting and receiving bus messages of a first channel type of a Flexray bus at a first channel interface of a Flexray controller and/or transmitting and receiving bus messages of a second channel type of the Flexray bus at a second channel interface of the Flexray controller,
and adapting bus messages of the first channel type received at the second bus interface to bus messages of the second channel type and relaying them to the second channel interface of the Flexray controller,
and/or adapting bus messages of the second channel type transmitted via the second channel interface of the Flexray controller to bus messages of the first channel type and relaying them to the second bus interface using at least one adapting module.

It is a basic concept of the present invention that, by means of a single Flexray controller or communication controller, a gateway for connecting two Flexray busses can be provided. With a minimum of effort, it is therefore possible to connect, for example, to an existing Flexray bus which may already be constructed in a motor vehicle, a new bus branch, also known as bus cluster, and to check its functionality. The procedure according to the invention allows work with a single Flexray controller, to make optimum use of its facilities and nevertheless to couple two similar channels or channels of the same type of different Flexray busses using the single Flexray controller present or required in the gateway.

The general formulations “first channel type” and “second channel type” were chosen because the first and the second channel type may be an A channel, but also a B channel. This makes no difference.

A gateway according to the invention may of course comprise a plurality of Flexray controllers, for example if a first controller is provided for coupling two A channels of two Flexray busses and a second Flexray controller is used to couple two B channels of two Flexray busses. The Flexray controller may for example be a part of a FPGA or another programmable circuit component.

In this context, too, it is advantageous that there is no need for several, for example two, Flexray controllers in one gateway for coupling channels of the same type of two Flexray busses. It is obvious that one Flexray controller requires less space or capacity in the programmable circuit component than two Flexray controllers.

The use of a single Flexray controller offers the further advantage that a tested and certified component—in hardware or software—is used in the gateway according to the invention, so that the gateway reliably behaves according to standard at the connected Flexray busses.

At this point, it should be noted that the Flexray gateway according to the invention can be implemented in hardware or in software or in both. Particularly preferred is an implementation in a programmable circuit component which can be used very efficiently. As a result, the gateway responds quickly and has a simple structure.

The Flexray gateway according to the invention is preferably used for simulation purposes, testing purposes or simply for linking two Flexray busses (or any combination of the above measures).

A particularly preferred application is the interference with bus messages for a bus node, in particular a control unit, for example, or for a segment of the Flexray cluster. A bus message can for example be modified by exchanging contents of the bus message, for example. In this way, for example, the receiving bus node, which may be a control unit, is confronted by modified information in order to check how the bus node will respond. It is therefore for example possible to test a control unit which is operated on the Flexray bus.

The incorporation of a new control unit into an existing Flexray bus for testing purposes can also be implemented easily with the gateway according to the invention. It is for example possible for the Flexray gateway to modify bus messages from the new control unit in such a way that they are understood by the other control units of the existing bus coupled by the Flexray gateway. The Flexray gateway according to the invention will for example transfer data from one frame received by the new control unit to another frame, which the Flexray gateway then transmits on the “old” Flexray bus to the other control units connected to this Flexray bus. The Flexray gateway according to the invention is therefore preferably configured for transferring data from one bus message or frame into another bus message or another frame.

The Flexray gateway according to the invention is extremely flexible and makes it possible not only to interfere with or modify a few frames, for example four or five frames, but also to change a plurality of frames or bus messages accordingly. The Flexray gateway is therefore very flexible and significantly expands testing facilities, for example, compared to existing technology.

The Flexray controller is expediently designed for generating simulation bus messages for dispatch at the first or second bus interface, using data provided at a feed-in interface of the Flexray gateway. The feed-in interface may for example be a part of the Flexray controller. The feed-in interface, which may include a buffer and/or a data interface or the like, can be read by the Flexray controller for generating the simulation bus message. At this point, it should be noted that a simulation bus message may be an interference message, but also any other message, such as a bus message containing information received at one Flexray bus, which information is then processed and made available for dispatch on the other Flexray bus by the Flexray controller. In this way, information from a frame received by the first Flexray bus can for example be “repackaged” into another bus message and transmitted at the other Flexray bus as a simulation bus message. The Flexray controller processes the data to form a bus message or prepares a bus message for the second Flexray bus, so that the gateway behaves according to standard at the second Flexray bus.

The Flexray controller is expediently designed for outputting the simulation bus messages at its second channel interface as a bus message of the second channel type, and the at least one adapting module is in turn designed for adapting this simulation bus message to a bus message of the first channel type. The Flexray controller therefore for example outputs a bus message suitable for a B channel, which is then converted by the adapting module into a bus message suitable for an A channel. The adapting module may for example substitute the check sum of the bus message.

The gateway according to the invention can output bus messages received on the first Flexray bus in a quasi-transparent way via the coupling means as bus messages on the second Flexray bus. As a result, the gateway operates very efficiently and fast. This arrangement can obviously be reversed, i.e. the gateway can relay bus messages or frames received on the second Flexray bus directly to the bus interface for the first Flexray bus. The Flexray controller does not participate in this process and expediently remains passive. Among other advantages, this promotes a very fast message switching. This mode of operation can also be referred to as bypass mode.

The Flexray controller can, however, be used efficiently for feeding bus messages into the first or second Flexray bus. It can for example process data provided at a feed-in interface into bus messages which are then, following their adaptation by the adapting module, output by the gateway at its first or second bus interface. This operating mode can also be referred to as simulation mode.

Switching between the simulation mode and the bypass mode is facilitated by the following measure: The Flexray gateway according to the invention preferably comprises at least one switching module for switching between a bypass mode, in which the coupling means output without change a bus message received by the first Flexray bus at the second bus interface and/or a bus message received by the second Flexray bus at the first bus interface, and a simulation mode, in which the coupling means output a simulation bus message made available by the Flexray controller, in particular in place of a bus message received at one of the bus interfaces of the Flexray gateway, at the first or second bus interface. In this way, a bus message can be relayed from one Flexray bus to the other Flexray bus, or it can be replaced by another bus message or another frame.

If operation is to be as problem-free and fast as possible, it is advantageous if the at least one switching module is located between the at least one adapting module and the second bus interface. In this way, a simulation bus message which may for example be provided by the Flexray controller can pass through the adapting module, be converted there for example into a simulation bus message of the first channel type (e.g. an A channel bus message) and then be directly relayed to the second bus interface by the at least one switching module.

The feed-in interface expediently comprises a buffer in which data for simulation bus messages can be made available. Data for one or more simulation bus messages can for example be provided. Data can therefore be provided for example in the buffer for a whole sequence or at least for parts of a sequence of frames. An advantageous further development of the invention provides that a control information which is read by a switching means, for example the switching module or a control module selecting the switching module, is assigned to the data for a respective simulation bus message, in order to switch the at least one switching module between the bypass mode, in which the switching module blocks a relaying of the simulation bus message, and a simulation mode, in which the at least one switching module relays a simulation message generated using the data in the buffer. In the bypass mode, the switching module for example relays a bus message from one Flexray bus to the other Flexray bus. In the simulation mode, on the other hand, such a bus message is blocked for example, and in place of this bus message the simulation message is transmitted to the bus interface.

The Flexray controller preferably comprises a monitoring interface for outputting bus messages transmitted between the first and second bus interfaces. The monitoring interface can of course be unidirectional or bidirectional, i.e. outputting only the bus messages transmitted from the first to the second bus interface or vice versa, or else operating in both directions of transmission. A simulation module or testing tool can for example be connected to the monitoring interface, such as a personal computer or another device with an output interface, e.g. a display, a loudspeaker or the like.

In this context, it should be mentioned that the above feed-in interface can be connected to such a testing tool.

The coupling of two similar channels across the gateway according to the invention could result in feedback effects. Against these, the following is proposed: The coupling means advantageously relay bus messages received at the first bus interface to the second bus interface, while blocking a relaying of bus messages received at the second bus interface to the first bus interface to avoid feedback. This situation can obviously be reversed, i.e. the coupling means relay bus messages received at the second bus interface to the first bus interface, while blocking a relaying of bus messages received at the first bus interface to the second bus interface to avoid feedback.

As mentioned above, the first channel type may correspond to an A channel of a Flexray bus or alternatively to a B channel. The adapting module is preferably provided for modifying a test information of the bus messages to be adapted, for example a check sum. There may of course also be a different adaptation if required.

The Flexray controller is expediently designed for time-synchronising the first bus interface with the second bus interface. The Flexray controller thus has a synchronisation function and enables both the first and the second Flexray bus to operate synchronously. The Flexray controller for example provides for a synchronous start-up of the two Flexray busses, synchronising the starting Flexray busses. It is preferably provided that the Flexray controller takes the time information preset by the first Flexray bus, for example the bus clock cycle, for synchronising or starting the second Flexray bus, or that it starts the second Flexray bus with this so-called cluster information and the timing of the first Flexray bus. The Flexray gateway for example transmits synchronisation messages (e.g. so-called sync frames) received from one Flexray bus to the other Flexray bus, or it generates from the received synchronisation messages new synchronisation messages for the other Flexray bus.

The gateway according to the invention expediently forms a part of a testing tool with which a communication between the first and the second Flexray bus can be tested. A communication between the first and the second Flexray bus can be simulated, for example. The testing tool can for example be provided for simulating a so-called rest bus. Alternatively, the testing tool can be provided for connecting a new component which is to be connected to an existing Flexray bus, for example a new engine control unit. The testing tool is then preferably designed for modifying messages from the “old” Flexray bus before they are relayed to the second, new Flexray bus, or vice versa. It is therefore an advantageous function of such a testing tool that a communication can be manipulated as well. As mentioned above, a checking function is advantageous as well, i.e. the testing tool being provided for checking the communication between the first and the second Flexray bus.

An advantageous function provides that the testing tool comprises simulation means for sending data received at the first bus interface in another bus message to the second bus interface or vice versa. The simulation means or simulation module may for example be provided for encoding a message in a manner of speaking, i.e. for example re-coding the user data from one time slot to another time slot for example, before they are relayed from one Flexray bus to the other Flexray bus.

The gateway according to the invention expediently comprises at least one bus transceiver, which in a manner of speaking serves the physical level or the physical layer of the Flexray bus to be connected.

### BRIEF DESCRIPTION OF THE DRAWINGS

An embodiment of the invention is explained below with reference to the drawing. Of the drawing:

FIG. 1 is a diagrammatic view of a motor vehicle with a Flexray bus to which a second Flexray bus is connected by means of a Gateway according to the invention shown diagrammatically;

FIG. 2 is a diagrammatic representation of a bus message transmitted on the Flexray bus of the motor vehicle; and

FIG. 3 is a diagrammatic view of a Flexray gateway according to the invention in combination with or as a part of a testing tool.

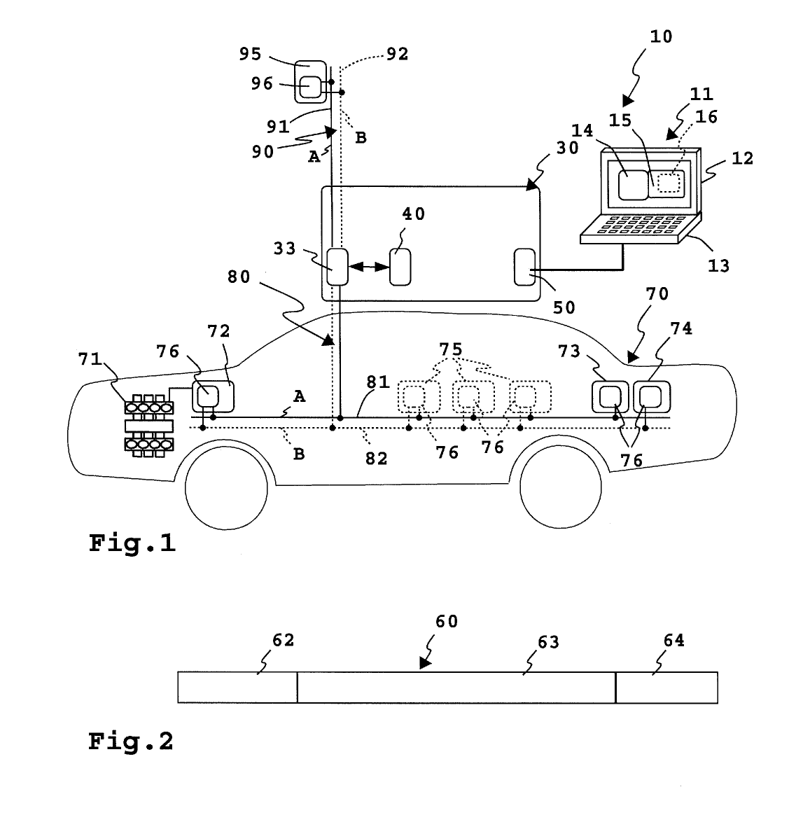

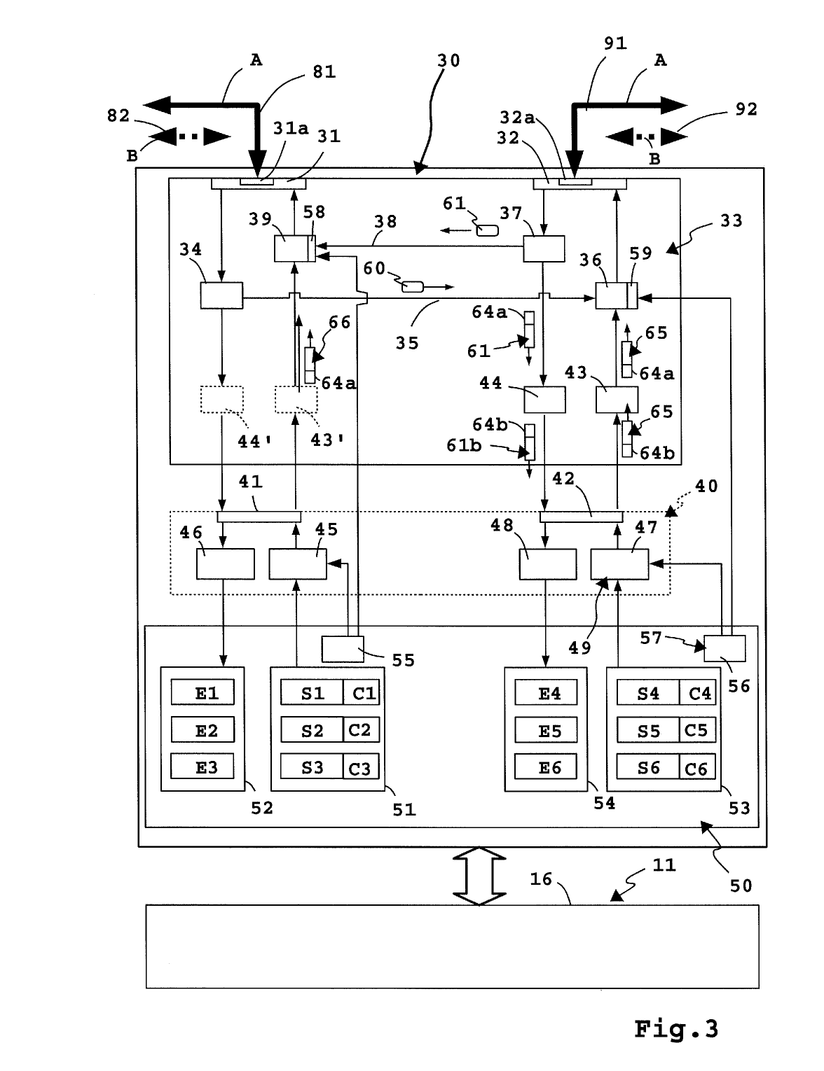

### DETAILED DESCRIPTION OF THE PREFERRED EMBODIMENTS

A motor vehicle 70, for example a car, has a drive motor 71, for example an internal combustion engine or an electric motor, as well as various other components, such as electric windows, an air conditioning system, lighting and the like. These components are for example controlled and monitored by electric control units 72, 73 and 74, such as an engine control unit for the drive motor 71, as well as further control units 75 illustrated diagrammatically; these are connected to a Flexray bus 80. The Flexray bus 80 has a so-called A channel 81 and a so-called B channel 82.

In the motor vehicle 70, however, only one of the two channels 81 or 82 is used in the usual way, this being the A channel in the present case. For this reason, the B channel is indicated by broken lines only.

Each of the control units 72 to 75 which are connected to the Flexray bus 80 has a Flexray bus coupler 76 for communication with the Flexray bus 80. The Flexray bus couplers 76 contain in the known way Flexray controllers, transceivers and the like, for example.

The Flexray bus 80 is to be supplemented by a Flexray bus 90, i.e. a further bus cluster. A control unit 95 provided for direct communication with the control units 72 to 75 is connected to the Flexray bus 90. In a later development phase, the control unit 95, which comprises a Flexray bus coupler 96 of the type of the Flexray bus couplers 76, is to be connected to the existing Flexray bus 80. Before this is done, however, it has to be ensured that the control unit 95 harmonises and communicates with the other control units 72 to 75. These tests and checks are facilitated by the testing tool 10, which is described in greater detail below and which comprises a gateway 30.

While the Flexray bus 80 forms a first Flexray bus, for example, the Flexray bus 90 is a second Flexray bus, the first and second busses 80 and 90 being coupled by the gateway 30. The control units 72 to 75 communicate with the A channel 81 of the Flexray bus 80. The control unit 95 is also connected to an A channel, in this case to an A channel 91 of the Flexray bus 90. The Flexray gateway 30 couples the two channels 81 and 91. The two channels 81 and 91 are therefore channels of a first channel type A.

The second channel 82 of the Flexray bus 80 and a second channel 92 optionally provided at the second Flexray bus 90 are channels of a second channel type B.

The gateway 30 comprises a first and a second bus interface 31 and 32, which are connected to the Flexray busses 80 and 90 with their first channels 81 and 91 (A channels), for example to the channel connections 31a and 32a. The channel connections 31a and 32a may include transceivers, for example. The interfaces 31 and 32 are coupled by coupling means 33, so that, for example, a bus message 60 from the Flexray bus 80 arrives at the interface 31 and is directly relayed or routed to the other bus interface 32 by the coupling means 33 in a bypass mode.

The bus message 60 is for example received by a receiver module 34 of the coupling means 33, which is assigned to the bus interface 31, and relayed, as indicated by an arrow 35, to a transmitter module 36 assigned to the bus interface 32. The transmitter module 36 in turn relays the bus message 60 to the second bus interface 32 for transmission on the second Flexray bus 90.

In the reverse direction, i.e. from the Flexray bus 90 to the Flexray bus 80, communication operates in the opposite sense, i.e. a bus message 61 received at the second bus interface 32 is received by a receiver module 37 and relayed—as indicated by an arrow 38—to a transmitter module 39, which then outputs the bus message 61 at the first bus interface 31 on the first Flexray bus 80.

A transmission of the bus message 60 from the first Flexray bus 80 to the second Flexray bus 90 could result in an undesirable feedback or positive feedback, if the bus message 60 in a manner of speaking returns to the receiver module 37 on the Flexray bus 90 and this then returns exactly the same bus message 60, which has already been transmitted once via the first Flexray bus 80, to this first Flexray bus 80. This feedback effect is eliminated by providing that the receiver module 37 does not return the bus message 60 via the connection as indicated by the arrow 38, but that this connection in a manner of speaking blocks the bus message 60 which has already been transmitted to the second bus interface 32.

The gateway 30 further comprises a Flexray controller 40 which is not active in the bypass mode described above.

The Flexray controller 40 is a certified and tested component comprising hardware and/or software in the present case. The Flexray controller 40 provides essential functions required for the operation of a Flexray bus, such as synchronisation functions and the like. In this sense, the Flexray controller 40 is an essential component of the gateway 30. For example, the Flexray controller 40 is responsible for the synchronisation or adaptation of the busses 80 and 90 and for adapting the gateway 30 to the bus cycle of the bus(ses) 80 and/or 90 in the start-up phase of the gateway 30, i.e. when the Flexray busses 80 and 90 start.

The Flexray controller 40 can therefore be a standardised component, having, like all Flexray controllers, two channel interfaces, i.e. a first and a second channel interface 41 and 42, which can serve a channel of a first channel type A and a channel of a second channel type B. The first channel may for example be an A channel and the second channel a B channel, so that the first channel interface 41 is suitable for serving an A channel or a channel of the first channel type A, while the second channel interface 42 is designed for serving a B channel and therefore a channel of the second channel type B. The channel interface 41 could therefore be connected directly to the bus interface 31, which is connected to the A channel 81 or the channel of the first channel type A of the first Flexray bus 80. The second channel interface 42, which is assigned to the second or B channel type, cannot simply be connected to the bus interface 32 assigned to the first channel type A, which serves the A channel 91 of the second Flexray bus 90.

In this respect, the adapting modules 43 and 44 of the coupling means 33 provide a remedy. The Flexray controller 40 can edit bus messages provided at a feed-in interface 49 or data provided for the provision of bus messages, in order to make available bus messages of the second channel type (B channel type) for relaying by the coupling means 33 at its second channel interface 42, which bus messages are then converted by the adapting module 43 into bus messages of the first channel type (A channel type), so that they can be output by the transmitter module 16 at the bus interface 32 of the gateway 30.

In the receiving direction, the adapting module 44 is active, i.e. the bus message 61 received by the receiver module 37, for example, which is a bus message of the first channel type (A channel type), is converted by the adapting module 44 into a bus message of the second channel type (B channel type) or adapted in such a way that the Flexray controller 40 can receive the bus message 61b at its second channel interface 42.

The bus messages 60 and 61 may for example consist a head 62, a user content 63 and a check information 64.

In the bus message 61, for example, the adapting module 44 replaces the check information 64a assigned to the first channel type (A channel) by a check information 64b assigned to the second channel type (B channel), enabling the second channel interface 42 of the Flexray controller 40 to “understand” this modified bus message 61b.

The gateway 30 has a test interface 50, which may for example allow for monitoring or tapping the communication between the two Flexray busses 80 and 90, for a feed-in of simulation bus messages, for a checking of the communication and the like.

A personal computer 11 of the testing tool 10 is or can be connected to the test interface 50, for example. The testing tool 10 is therefore provided with outputting means 12, such as a display of the computer 11, and with inputting means 13, such as a keyboard, a mouse, speech recognition or the like of the computer 11, enabling an operator to influence the data exchange of the gateway 30 by means of the test interface 50 and/or to monitor this data exchange. The computer 11 further comprises a processor 14 and a memory 15, and a test module 16 the programme code of which the processor 14 can execute is stored in the memory 15.

The gateway 30 may for example be designed as a plug-in card which can be placed in a module slot of the computer 11 for communication with the processor 14 and the other components of the computer 11. In this case the test interface 50 will for example comprise a PCMIA or PCI interface or the like. The gateway 30 may of course alternatively be an integral part of a testing tool, i.e. the gateway 30 may be integrated into the computer 11 or the like. The architectural details, however, are irrelevant in this context. The important aspect is the monitoring, manipulation etc. of the data exchange via the gateway 30 with the aid of the computer 11 or the test module 16. This will be explained below.

The Flexray controller 40 for example comprises an A channel receiver module 46, which can receive bus messages received at the A channel or first channel interface 41, for example the bus messages 60, and write them into an A channel receiving buffer 52 of the test interface 50. The test module 16 communicates with the test interface 60 and can therefore for example read the receiving buffer 52, where input data such as E1, E2 and E3 are written, which may for example stem from the bus message 60 or from bus messages not shown in the drawing.

The Flexray bus 90 is likewise assigned such a receiving buffer, i.e. a B channel receiving buffer 54 assigned to the second channel interface 42 and to be written into by a B channel receiving module 48. Into the receiving buffer 54, the receiving module 48 may for example write bus messages received on the second Flexray bus 90 or data contained in these bus messages, of which input data E4, E5 and E6 are shown by way of example. The test module 16 can of course read the input or receiving buffer 54 as well.

This represents a monitoring process by way of example. Other architectural solutions are obviously feasible as well.

For feeding in simulation bus messages or for recoding data from a received bus message into another bus message to be transmitted, an A channel transmitting buffer 51 and a B channel transmitting buffer 53 are provided; these are read by A and B channel transmitting modules 45 and 47 of the Flexray controller 40 in order to send data provided by the test module 16 on the first Flexray bus 80 or the second Flexray bus 90 as Flexray bus messages.

Data S1, S2 and S3 and S4, S5 and S6 respectively are for example stored in the transmitting buffers 51 and 53. For these data S1 to S6, control information C1 to C6 is stored in the transmitting buffers 51 and 53, by means of which control modules 55 and 56 instruct the transmitting modules 45 and 47 to read a respective data record S1, S2 and S3 or S4, S5 and S6, in order to prepare, using this data record, a bus message for sending on the Flexray bus 80 or 90. The control modules 55 and 56 form control means 57.

Bus messages are for example fed in as follows: The control module 56 selects the transmitting module 47 of the Flexray controller 40 to read out the data S4, if the control information C4 provides for this. The control information C4 may for example be logic “1”. Using the data S4, the Flexray controller 40, i.e. the transmitting module 47, forms a simulation bus message 65 with a check information 64b and outputs this to the second channel interface 42. The adapting module 43 replaces the check information 64b by an A channel check information 64a. The control module 56 then selects the transmitting module 36 of the coupling means 33 to transmit the simulation bus message 65, for example in place of the bus message 60. The transmitting module 36 may for example comprise an upstream switching module 59, which may be an integral part of the transmitting module 36. The switching module 59 instructs the transmitting module 36 to transmit the simulation bus message 65.

In the Flexray bus 80, there is no need for adaptation to another channel type. For example, the control module 55 can directly select the Flexray controller 40, i.e. the A channel transmitting module 45, generate a simulation bus message 66 from the data record S1 or S2 and output it at the channel interface 41. The control module 55 further selects a switching module 58, which may be on board of the transmitting module 39 of the coupling means 33, for example in order to output the bus simulation message 66 at the bus interface 31 in place of the bus message 61.

The control information C2, C3 or C5 and C6 can for example indicate that the data records S2, S3 or S5, S6 respectively are, unlike the data records S1 and S4, not to be converted into bus messages.

Using the control information C1 to C6, the gateway 30 can for example manipulate several frames of a transmitting cycle, i.e. generate a simulation frame instead of a received frame and then transmit this, or it can route bus messages in a bypass mode transparently from one Flexray bus to the other Flexray bus.

There is obviously also the possibility of an exclusive tapping or monitoring mode in which the bus traffic or data exchange over the gateway is not affected.

The above explanations of the illustrated embodiment describe individual modules of a gateway. Such a module may obviously be a logic component, a software function or the like. However, the above description indicates a way in which a gateway according to the invention can be constructed in principle.

1. A Flexray gateway comprising a first bus interface for connecting a first Flexray bus and a second bus interface for connecting a second Flexray bus, wherein the Flexray gateway comprises coupling means for coupling a first Flexray bus to a second Flexray bus and for transmitting bus messages between the first and the second Flexray bus, wherein the Flexray gateway comprises a Flexray controller with a first channel interface for transmitting and receiving bus messages of a first channel type of a Flexray bus and a second channel interface for transmitting and receiving bus messages of a second channel type of a Flexray bus, and wherein the coupling means are configured for coupling a channel connection of the first bus interface, which is provided for transmitting bus messages of the first channel type to a channel connection of the second bus interface, which is likewise provided for transmitting bus messages of the first channel type, and wherein the coupling means comprise at least one adapting module for adapting bus messages of the first channel type received at the second bus interface to bus messages of the second channel type and for relaying them to the second channel interface of the Flexray controller and/or for adapting bus messages of the second channel type transmitted via the second channel interface of the Flexray controller to bus messages of the first channel type and for relaying them to the second bus interface.

2. A Flexray gateway according to claim 1, wherein the Flexray controller is designed for generating simulation bus messages for dispatch at the first or second bus interface using data provided at a feed-in interface of the Flexray gateway.

3. A Flexray gateway according to claim 2, wherein the Flexray controller is designed for outputting the simulation bus messages at its second channel interface as a bus message of the second channel type, and wherein the at least one adapting module is designed for adapting the simulation bus message to a bus message of the first channel type.

4. A Flexray gateway according to claim 1, further comprising at least one switching module for switching between a bypass mode, in which the coupling means output without change a bus message received by the first Flexray bus at the second bus interface and/or a bus message received by the second Flexray bus at the first bus interface, and a simulation mode, in which the coupling means output a simulation bus message made available by the Flexray controller in place of a bus message received at one of the bus interfaces of the Flexray gateway at the first or second bus interface.

5. A Flexray gateway according to claim 4, wherein the at least one switching module is located between the at least one adapting module and the second bus interface.

6. A Flexray gateway according to claim 4, wherein the feed-in interface comprises a buffer in which data for at least one simulation bus message can be made available, and wherein a control information assigned to the data can be stored in the buffer, wherein control means are provided which select the at least one switching module for switching between the bypass mode, in which the switching module blocks the relaying of a simulation message generated from the data in the buffer, and the simulation mode, in which the at least one switching module relays a simulation message generated from the data in the buffer.

7. A Flexray gateway according to claim 1, wherein the Flexray controller comprises a monitoring interface or a test interface for outputting bus messages transmitted between the first and second bus interfaces.

8. A Flexray gateway according to claim 1, wherein the coupling means relay bus messages received at the first bus interface to the second bus interface, while blocking a relaying of bus messages received at the second bus interface to the first bus interface to avoid feedback, or wherein the coupling means relay bus messages received at the second bus interface to the first bus interface, while blocking a relaying of bus messages received at the first bus interface to the second bus interface to avoid feedback.

9. A Flexray gateway according to claim 1, wherein the first channel type corresponds to an A channel or a B channel of a Flexray bus, and/or wherein the at least one adapting module is provided for modifying or for replacing a test information of the bus messages to be adapted.

10. A Flexray gateway according to claim 1, wherein the Flexray controller is designed for time-synchronising the first bus interface with the second bus interface during a bus starting phase.

11. A Flexray gateway according to claim 1, wherein the Flexray gateway forms a part of a testing tool which is provided for a motor vehicle and with which a communication between the first and the second Flexray bus can be simulated and/or manipulated and/or tested.

12. A Flexray gateway according to claim 11, wherein the testing tool comprises simulation means for sending data received at the first bus interface in another bus message to the second bus interface and/or vice versa.

13. A method for operating a Flexray gateway comprising a first bus interface for connecting a first Flexray bus and a second bus interface for connecting a second Flexray bus, the method comprising:
coupling a channel connection of the first bus interface, which is provided for transmitting bus messages of the first channel type to a channel connection of the second bus interface, which is likewise provided for transmitting bus messages of the first channel type, and transmitting bus messages between the channel connections;
transmitting and receiving bus messages of a first channel type of a Flexray bus at a first channel interface of a Flexray controller and/or transmitting and receiving bus messages of a second channel type of Flexray bus at a second channel interface of the Flexray controller;
and adapting bus messages of the first channel type received at the second bus interface to bus messages of the second channel type and relaying them to the second channel interface of the Flexray controller;
and/or adapting bus messages of the second channel type transmitted via the second channel interface of the Flexray controller to bus messages of the first channel type and relaying them to the second bus interface using at least one adapting module.
